(19) United States
(12) Patent Application Publication
(10) Pub. No.: US 2005/0184215 A1
(43) Pub. Date: Aug. 25, 2005

(54) Spiral spring for a liquid crystal display stand

(76) Inventor: Yu-sen Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/780,657

(22) Filed: Feb. 19, 2004

(51) Int. Cl. F16M 11/14

(52) U.S. Cl. 248/676; 248/920

(57) ABSTRACT

A spiral spring for a liquid crystal display stand includes a sliding base, a sliding block, and a spiral spring. The sliding block slides along rails in the sliding base. One end of the sliding block has holes to secure one end of the spiral spring which has the other end secured to holes of the sliding base. The spiral spring has a pair of bending edges to form an angle with respect to the spring to reinforce the strength of the spring.

### FIELD OF THE INVENTION

This invention relates to a spiral spring for a liquid crystal display stand, and more particularly to a spiral spring with a pair of bending edges on respective sides to reinforce the strength of the spring and to prevent metal fatigue.

### BACKGROUND OF THE INVENTION

A LCD monitor has been widely adapted by computer users for its compact size, weight and radiation free. Inventors are working to improve its capability, such as the size. The height adjustment is also one of the improvements. As shown in FIG. 8, the product comprises a sliding base A having a slot A2 therein, a spiral spring A3 secured on the top end of the sliding base A thereof One end of the spiral spring A3 is secured to the bottom end of a sliding block A4. The sliding base A1 comprises a pair of rails A5 for the sliding block A4 to slide along. The top end of the sliding block A4 is for a liquid crystal display (LCD) A6 to seat thereon. By pushing the sliding block A4, the LCD A6 will slide down along with the sliding block A4, as shown in FIG. 9. Upon the LCD A6 reaches to a desired position, the pushing force is released and the LCD A6 will stay at the position. To lift the LCD A6, a user may pull up the sliding block A4. A restoring force from the spiral spring A3 facilitates the upright movement. The spiral spring A3 is designed to support the weight of the LCD A6. The larger the LCD A6 is, the heavier it will be. This causes a heavier load to the spiral spring A3. After a certain period of time, metal fatigue will happen to the spiral spring A3.

### SUMMARY OF THE INVENTION

It is the primary object of the present invention to provide a spiral spring for a liquid crystal display stand, which has a stronger structure.

It is another object of the present invention to provide a spiral spring for a liquid crystal display stand, which can last longer.

It is a further object of the present invention to provide a spiral spring for a liquid crystal display stand, which is safe in use.

### BRIEF DESCRIPTION OF THE DRAWINGS

FIG. 1 is an exploded view of the present invention;

FIG. 2 is a side view of the present invention, with partial sectioned;

FIG. 3 is a perspective view of the present invention;

FIG. 4 is a side view showing an operation of a sliding block of the present invention;

FIG. 5 is a side view of a spiral spring of the present invention;

FIG. 6 is a perspective view of a spiral spring of a second embodiment of the present invention;

FIG. 7 is a side view of the spiral spring of the second embodiment of the present invention;

FIG. 8 is an exploded view of a prior art, and

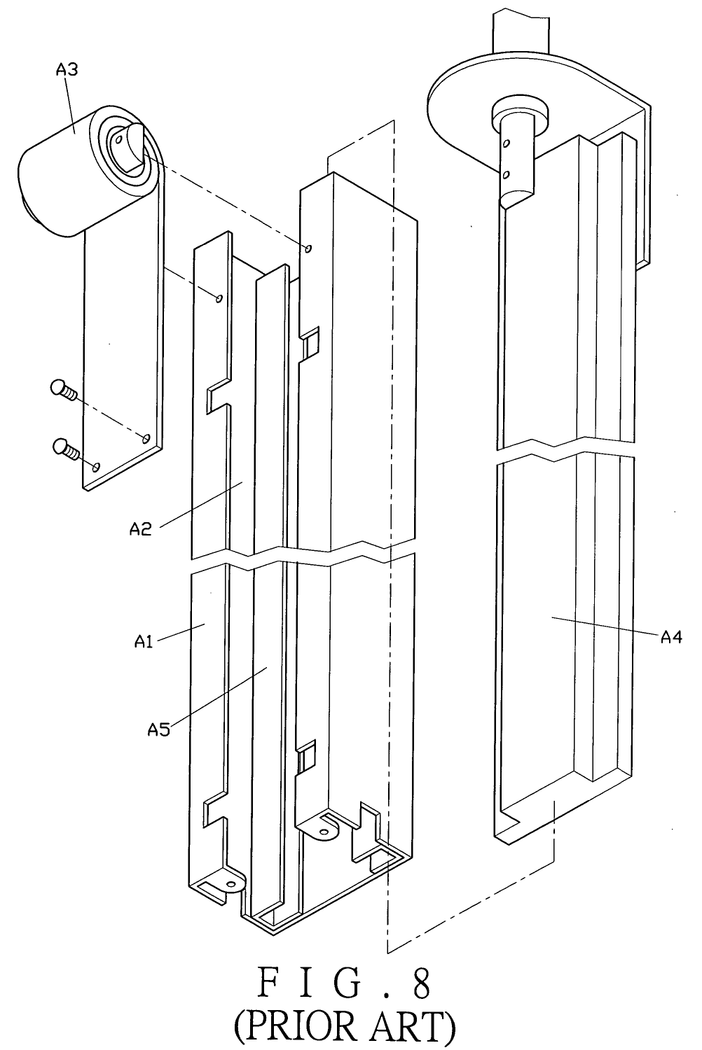

FIG. 9 is a side view of FIG. 8.

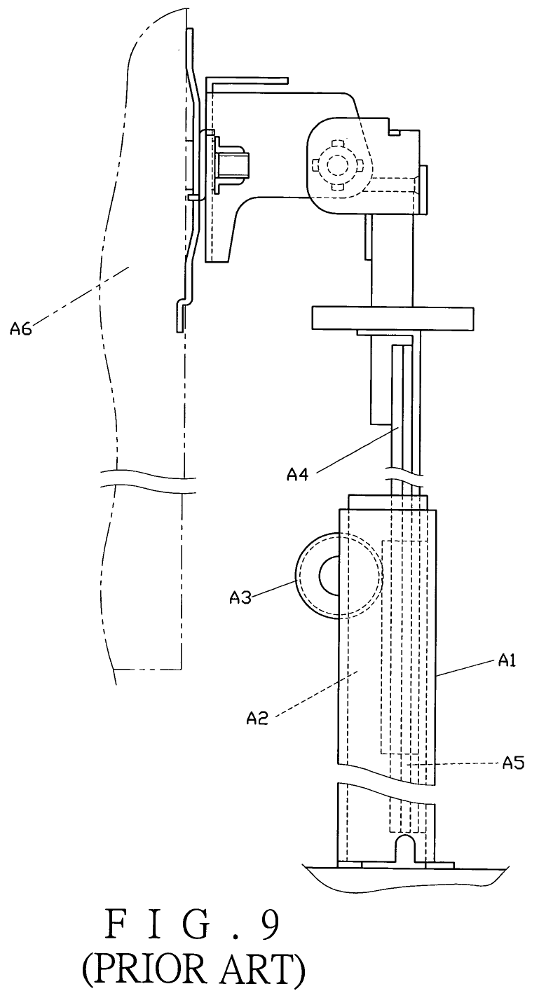

### DETAILED DESCRIPTION OF THE PREFERRED EMBODIMENT

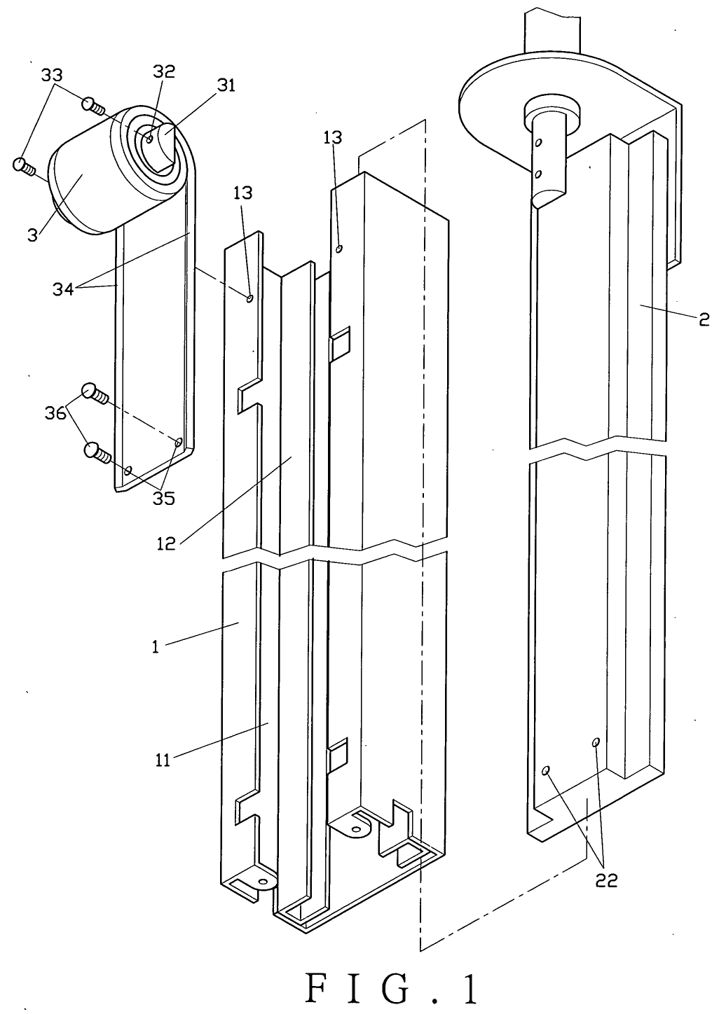

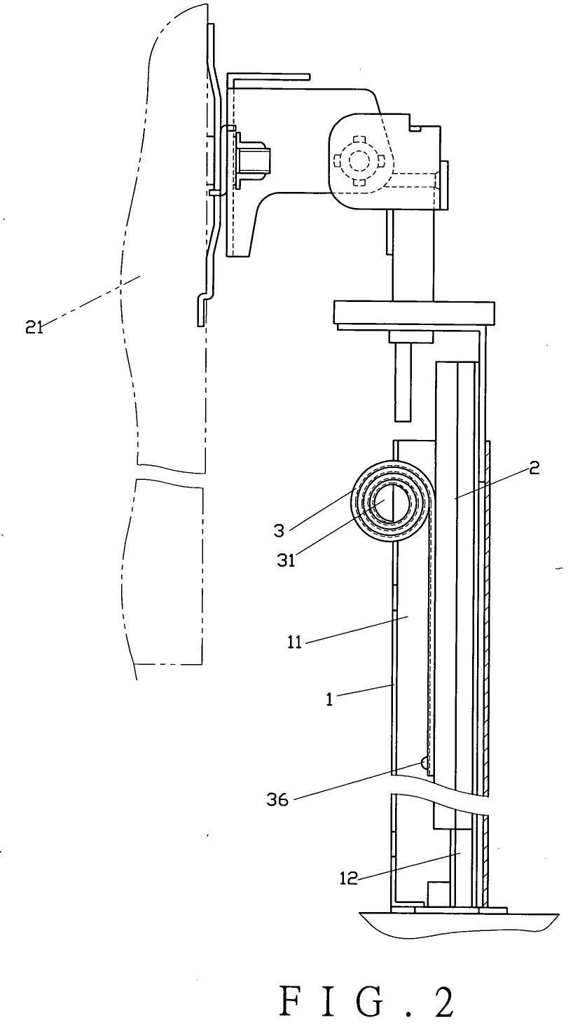

As shown in FIGS. 1 and 2, the present invention is generally composed of a sliding base 1, a sliding block 2 and a spiral spring 3.

The sliding base 1 comprises a slot 11 having a pair of rails 12 installed therein, and a pair of holes 13 on the top end thereof.

The sliding block 2 is set within the sliding base 1 and slides along the rails 12. The top end of the sliding block 2 is secured with a liquid crystal display (LCD) monitor 21. The lower section of the sliding block 2 has a pair of holes 22.

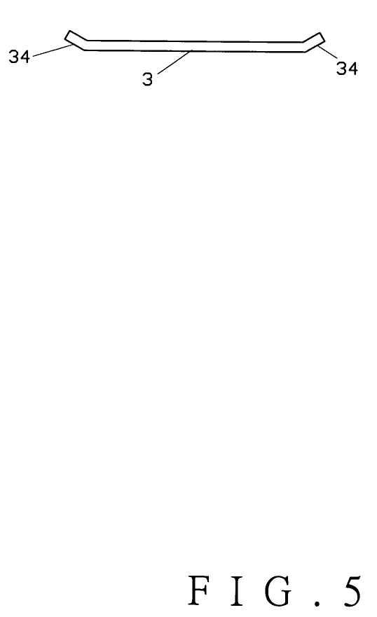

The spiral spring 3 comprises a shaft 31 for the spring 3 to roll thereon. The shaft 31 has a pair of holes 32 on respective ends. The spiral spring 3 has two bending edges 34 at respective sides to form an angle with respect to the spring, as shown in FIG. 5. One end of the spiral spring 3 has a pair of holes 35 to be secured by fasteners 36 to the holes 22 of the sliding block 2.

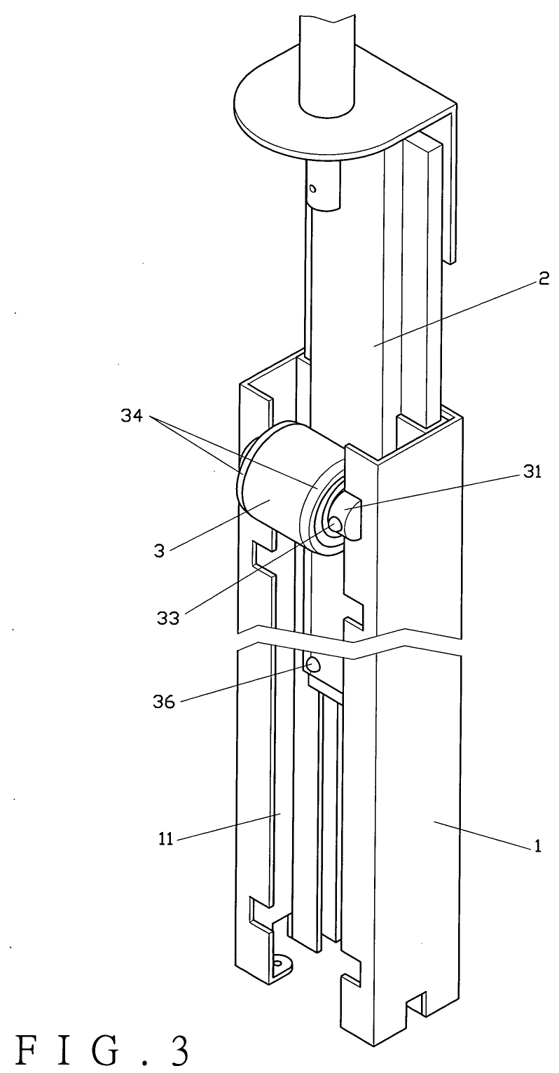

To assemble the present invention, as shown in FIGS. 2 and 3, the spiral spring 3 is secured to the sliding base 1 with fasteners 33 inserting through the holes 32 of the shaft 31 to the holes 13 of the sliding base 1. The bottom end of the spiral spring 3 is secured to the sliding block 2 by the fasteners 36 inserting through the holes 35 of the spiral spring 3 to the holes 22 of the sliding block 2. The sliding block 2 is placed into the sliding base 1 in the position that it can slide along the rails 12 of the sliding base 1.

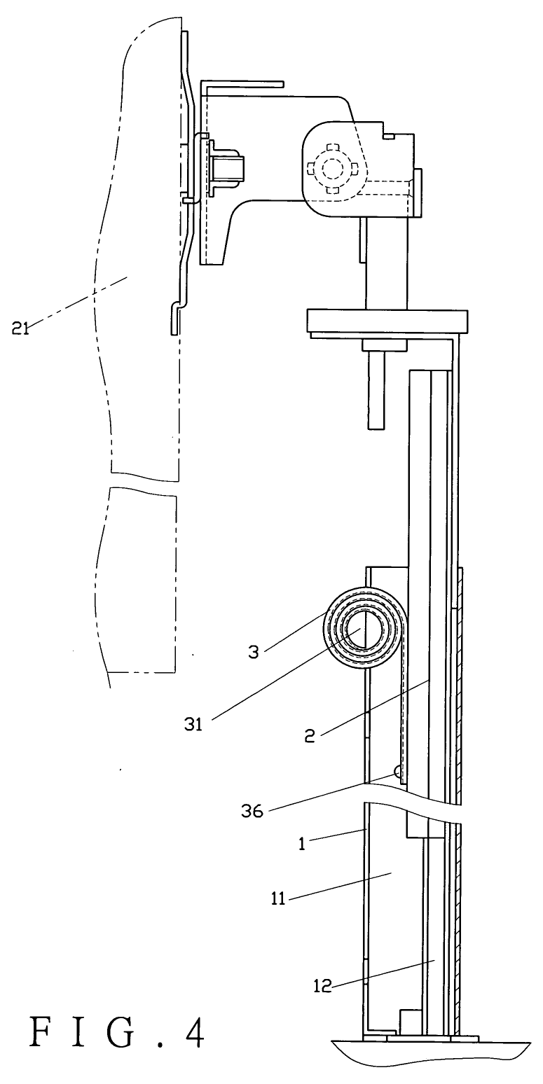

To operate the present invention, as shown in FIG. 4, the sliding block 2 is pushed downward when the sliding block 2 is moved downward. The spiral spring 3 extends with the movement. Upon reaching to a desired position, the pushing force is released and the sliding block 2 will remain at the position. The bending edges 34 of the spiral spring 3 provide a reinforce structure, which not only sustains the sliding block 2 at place but also minimizes the time for metal fatigue to be happened.

To adjust the height of the LCD monitor 21 to a higher position, the sliding block 2 is pulled upward. The spiral spring 3 will provide a restoring force to lift the sliding block 2. Upon the LCD monitor 21 reaches to a desired position, the pulling force is released and the sliding block 2 will remain still at the position. The bending edges 34 of the spiral spring 3 may roll without affecting the extension and retreating movement.

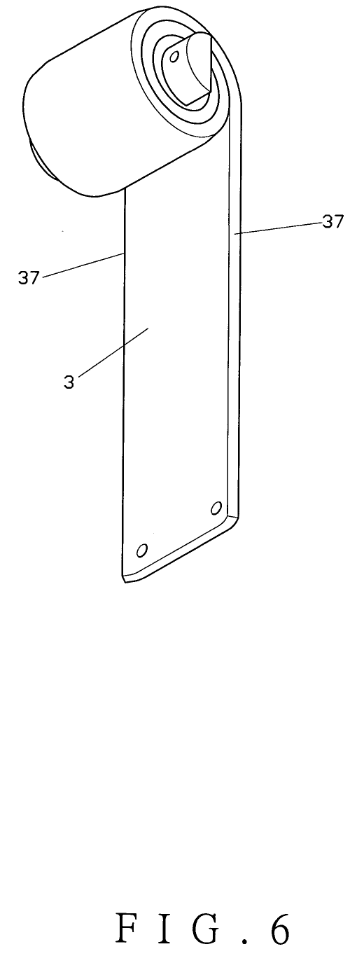

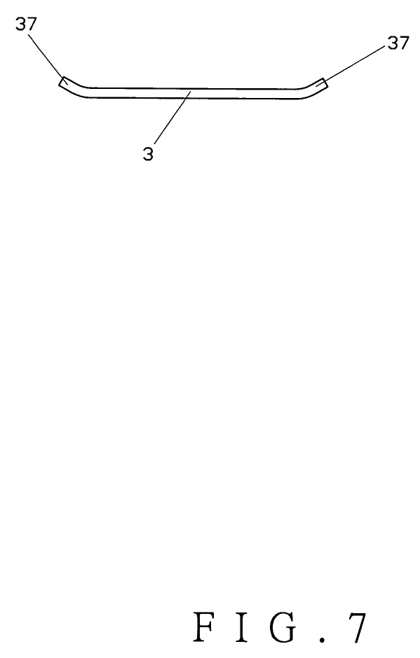

The other embodiment of the present invention, as shown in FIGS. 6 and 7, the spiral spring 3 has arc-shaped bending edges 37 at respective sides that may be rolled and collapsed fast. This design reinforces the strength of the spiral spring 3 and provides a better support.

1. A spiral spring for a liquid crystal display stand comprising:
a sliding base having a slot with a pair of rails therein;
a sliding block to be slid within said sliding base along said rails, a top end of said sliding block being adapted for a liquid crystal display monitor to be seated and secured thereon;
a longitudinally extended spiral spring secured onto said sliding base, one longitudinal end of said spiral spring being rolled on a shaft to provide a longitudinally directed bias force to another longitudinal end of said spiral spring secured to a bottom end of said sliding block, and characterized by:
said spiral spring having two bending edges at respective lateral sides thereof to form an angle with respect to a longitudinally extended intermediate portion of said spiral spring.

2. A spiral spring for a liquid crystal display stand comprising:
a sliding base having a slot with a pair of rails therein;
a sliding block to be slid within said sliding base along said rails, a top end of said sliding block being adapted for a liquid crystal display monitor to be seated and secured thereon;
a longitudinally extended spiral spring secured onto said sliding base, one longitudinal end of said spiral spring being rolled on a shaft to provide a longitudinally directed bias force to another longitudinal end of said spiral spring secured to a bottom end of said sliding block, and characterized by:
said spiral spring having two bending edges at respective lateral sides thereof with a longitudinally extended intermediate portion therebetween, said bending edges of said spiral spring are in an arc shape.
